(19) United States
(12) Patent Application Publication
(10) Pub. No.: US 2026/0354620 A1
(43) Pub. Date: Nov. 12, 2026

(54) AIR FRYER WITH REMOVABLE COMPONENTS

(71) Applicant: The Steelstone Group LLC, Brooklyn, NY (US)

(72) Inventors: Naphtali H. Biegeleisen, Brooklyn, NY (US); Binyumen Itzkowitz, Brooklyn, NY (US); Meilech Friedman, Linden, NJ (US); Kalman Wertzberger, Brooklyn, NY (US); Robyn De Luca, Queens, NY (US); Wenhui Huang, Brooklyn, NY (US); Joseph Deutsch, Brooklyn, NY (US)

(73) Assignee: The Steelstone Group LLC, Brooklyn, NY (US)

(21) Appl. No.: 19/575,489

(22) Filed: Mar. 23, 2026

Related U.S. Application Data
(60) Provisional application No. 63/775,471, filed on Mar. 21, 2025.

(51) Int. Cl. A47J 37/06; A47J 27/00; A47J 36/16; H05B 1/00

(52) U.S. Cl. CPC A47J 37/0641; A47J 27/004; A47J 36/16; H05B 1/00

(57) ABSTRACT

An air fryer assembly includes a housing enclosing an inner cooking chamber, an airflow generator for generating airflow within the inner cooking chamber, and a heating element in a path of airflow generated by the airflow generator. Air circulated by the airflow generator within the inner cooking chamber is heated by the heating element. Also included is a removable airflow module, the removable airflow module containing at least a portion of the airflow generator. The removable airflow module is removable from the housing. During use of the air fryer assembly, the removable airflow module is inserted into the housing and the housing locates the airflow generator and the heating element relative to the inner cooking chamber.

### CROSS REFERENCE TO RELATED APPLICATIONS

This application claims the benefit under 35 USC 119(e) from U.S. Provisional Application No. 63/775,471, filed on Mar. 21, 2025, the entire contents of which are incorporated by reference herein.

### FIELD OF THE INVENTION

The present disclosure generally relates to an air fryer, namely an air fryer with removable components designed to ease cleaning of the air fryer.

### BACKGROUND

Cooking appliances, including air fryers are very popular. However, many cooking appliances, such as air fryers, have fully enclosed structures which are difficult to clean.

Air fryers are cooking appliance that use rapidly circulated hot air to cook food, achieving a crispy texture similar to deep-frying, but with significantly less oil. As such, air fryers function by circulating hot air within a housing during the cooking process, such that the air passes food being cooked, a circulating fan, and a heating element. Accordingly, all elements are exposed to food particles, and are often difficult or impossible to clean.

There is a need for a cooking appliance, such as an air fryer, in which cleaning of internal components is made easier.

### SUMMARY

Provided herein is an air fryer assembly including a housing enclosing an inner cooking chamber, an airflow generator for generating airflow within the inner cooking chamber, and a heating element in a path of airflow generated by the airflow generator. Air circulated by the airflow generator within the inner cooking chamber is heated by the heating element.

Also included is a removable airflow module, the removable airflow module containing at least a portion of the airflow generator. The removable airflow module is removable from the housing. During use of the air fryer assembly, the removable airflow module is inserted into the housing and the housing locates the airflow generator and the heating element relative to the inner cooking chamber.

In some embodiments, the removable airflow module comprises an airflow generator tray, where the portion of the airflow generator is fixed within the airflow generator tray, and removal of the removable airflow module includes removal of the airflow generator tray from the housing.

In some such embodiments, the airflow generator is a motorized fan comprising a fan driven by a motor. The fan or a portion of the fan is then positioned within the airflow generator tray and the motor is fixed within the housing, and upon the removal of the airflow generator tray from the housing, the motor remains fixed within the housing.

In some such embodiments, the air fryer assembly includes a release mechanism for enabling or actuating the removal of the removable airflow module from the housing. In some such embodiments, the release mechanism includes a fan shaft release, and actuation of the release mechanism allows for the separation of a shaft driven by the motor from the airflow generator. In some embodiments utilizing a release, the release mechanism is a button which releases the removable airflow module from the housing.

In some embodiments in which the airflow generator is a motorized fan, the air fryer assembly includes a magnetic coupling for mating the motor with the fan or portion of the fan, such that removal of removable airflow module from the housing decouples the magnetic coupling and reinsertion of the removable airflow module recouples the magnetic coupling.

In some such embodiments, a first hub of the magnetic coupling is fixed to an end of a shaft of the motor and applies torque to a second hub of the magnetic coupling fixed to the fan or portion of the fan. In some such embodiments, the second hub is integrated into the fan or the portion of the fan. In some embodiments, the torque may be applied across an air gap.

In some embodiments incorporating a magnetic coupling, the second hub is mated to the fan or the portion of the fan by way of a fan shaft, and the fan shaft passes through the airflow generator tray such that the fan or portion of the fan and the second hub are on opposite sides of the airflow generator tray.

In some embodiments utilizing an airflow generator tray, the airflow generator includes a shroud, and upon removal from the housing, the portion of the airflow generator and the shroud are removable from the airflow generator tray.

In some embodiments utilizing an airflow generator tray, the heating element is fixed within the airflow generator tray and located relative to the airflow generator by the airflow generator tray. Removal of the removable airflow module from the housing may then remove both the airflow generator and the heating element from the housing.

In some such embodiments, the heating element is a heating coil powered by a power source associated with the housing by way of an electric contact associated with the removable airflow module, and removal of the removable airflow module disconnects the electric contact associated with the removable airflow module from the power source.

In some embodiments where the heating element is fixed within the airflow generator tray, the removable airflow module is provided in two parts, such that a portion of the removable airflow module associated with the airflow generator may be removed from the housing in combination with or independently of a portion of the removable airflow module associated with the heating element.

In some embodiments where the heating element is fixed within the airflow generator tray, upon removal from the housing, the airflow generator and the heating element are removable from the removable airflow module.

In some embodiments utilizing an airflow generator tray, the heating element is fixed within the housing, and during use, the airflow generator tray is positioned between the heating element and a top of the housing.

In some embodiments, the air fryer assembly includes a cooking basket slidably removable from the inner cooking chamber, where the cooking basket slides out of the inner cooking chamber by way of a front wall of the housing.

In some such embodiments, the cooking basket is integrated into the front wall of the housing, such that the front wall of the housing and the cooking basket are removed from the inner cooking chamber together.

In some embodiments utilizing a cooking basket removable from the front wall, the removable airflow module is removable from a back wall of the housing. Upon removal of the cooking basket and the removable airflow module from the housing, the inner cooking chamber is accessible for cleaning through both the front wall and the back wall.

### BRIEF DESCRIPTION OF THE DRAWINGS

FIG. 1 is an air fryer assembly in accordance with this disclosure.

FIG. 2 is a side view of the air fryer assembly of FIG. 1.

FIG. 3 is a rear perspective view of the air fryer assembly of FIG. 1.

FIG. 4 is a rear view of the air fryer assembly of FIG. 1.

FIG. 5 is a section view of the air fryer assembly of FIG. 1 taken along line 5-5.

FIG. 6 is a section perspective view of the air fryer assembly of FIG. 1 taken along line 5-5.

FIG. 7 is a section perspective view of a portion of the air fryer assembly of FIG. 1 taken along line 7-7.

FIG. 8 is the air fryer assembly of FIG. 1 with an airflow generator tray removed.

FIG. 9 is a rear perspective view of the air fryer assembly of FIG. 1 with the airflow generator tray removed.

FIGS. 10 and 11 are the airflow generator tray of FIG. 8.

FIG. 12 is the air fryer assembly of FIG. 1 with the airflow generator tray and a front wall of the housing removed.

FIG. 13 is a second embodiment of an air fryer assembly in accordance with this disclosure.

FIG. 14 is a side view of the air fryer assembly of FIG. 13.

FIG. 15 is a rear view of the air fryer assembly of FIG. 13.

FIG. 16 is a section view of the air fryer assembly of FIG. 13 taken along line 16-16.

FIG. 17 is a section perspective view of the air fryer assembly of FIG. 13 taken along line 16-16.

FIG. 18 is the air fryer assembly of FIG. 13 with a removable airflow module removed.

FIG. 19 is a rear perspective view of the air fryer assembly of FIG. 13 with the removable airflow module removed.

FIGS. 20 and 21 are the removable airflow module of FIG. 18.

FIG. 22 is the removable airflow module of FIG. 18 with a portion of an airflow generator separated therefrom.

FIG. 23 is a section view of an airflow generator for use in the air fryer assembly of FIG. 13.

FIGS. 24 and 25 are an alternative embodiment of a removable airflow module for use in the air fryer assembly of FIG. 13.

FIG. 26 is a hub of a magnetic coupling for use in the alternative embodiment of the removable airflow module of FIG. 24.

FIG. 27 shows the hub of the magnetic coupling of FIG. 26 mated with a portion of an airflow generator removed from the removable airflow module of FIG. 24.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

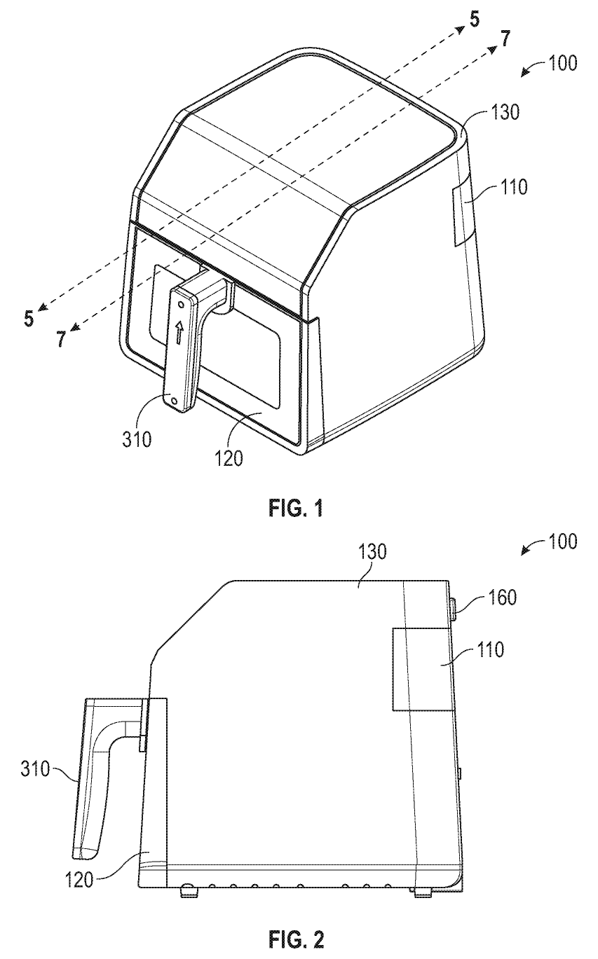

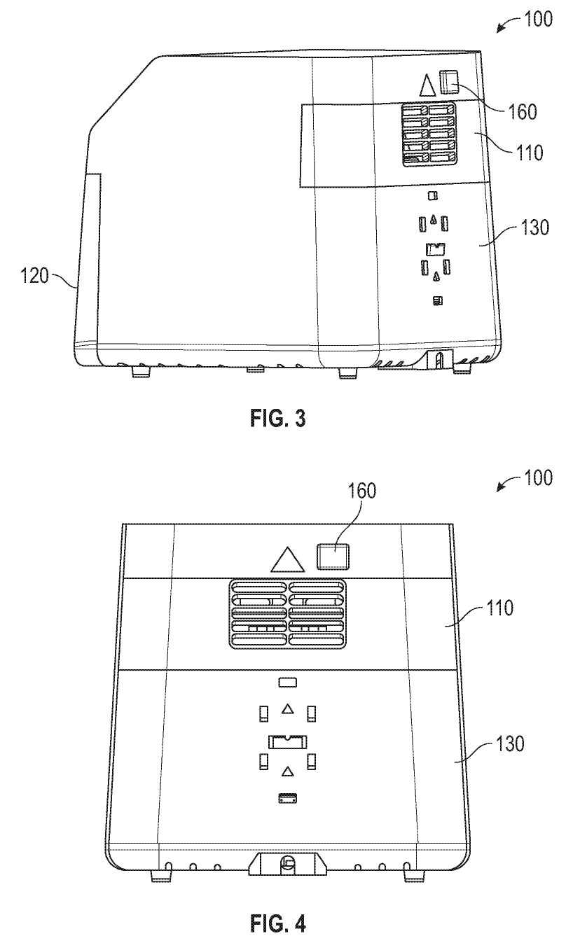

FIG. 1 is an air fryer assembly 100 in accordance with this disclosure. FIG. 2 is a side view of the air fryer assembly 100 of FIG. 1. FIG. 3 is a rear perspective view of the air fryer assembly 100 of FIG. 1. FIG. 4 is a rear view of the air fryer assembly 100 of FIG. 1.

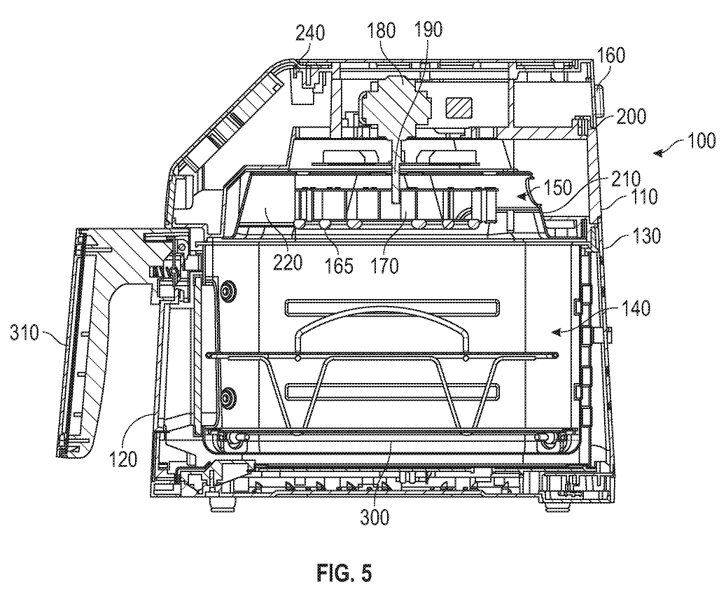

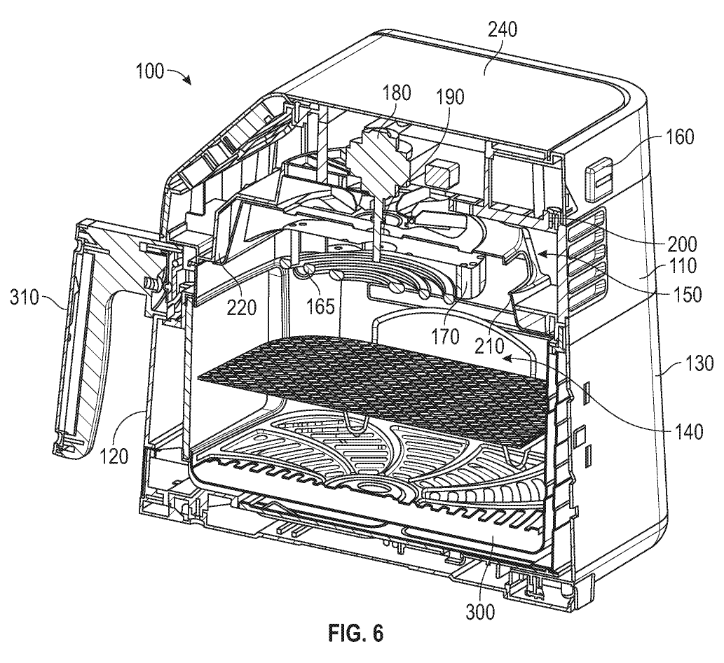

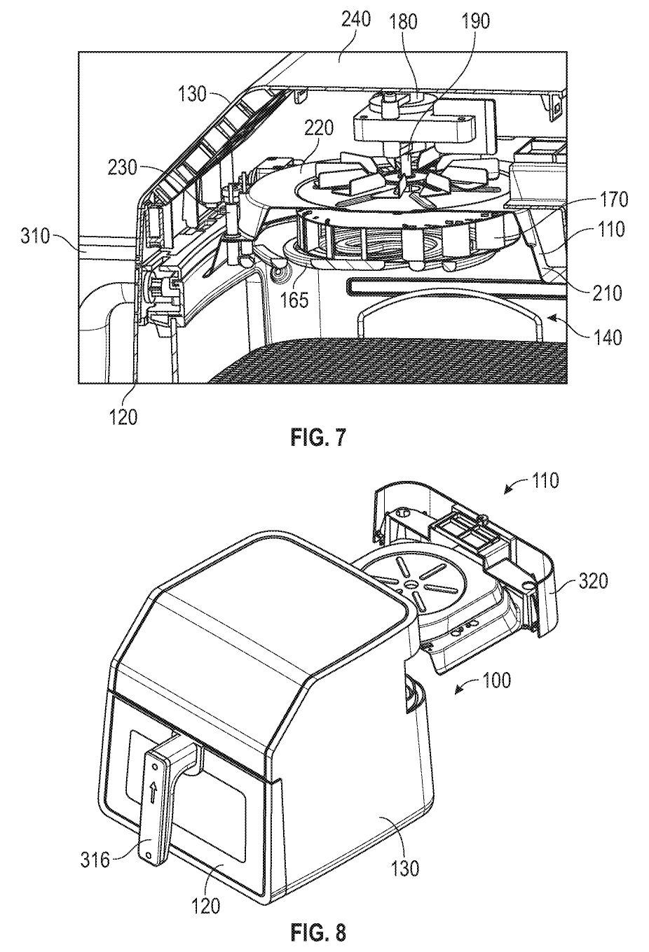

FIG. 5 is a section view of the air fryer assembly 100 of FIG. 1 taken along line 5-5. FIG. 6 is a section perspective view of the air fryer assembly 100 of FIG. 1 taken along line 5-5. FIG. 7 is a section perspective view of a portion of the air fryer assembly 100 of FIG. 1 taken along line 7-7.

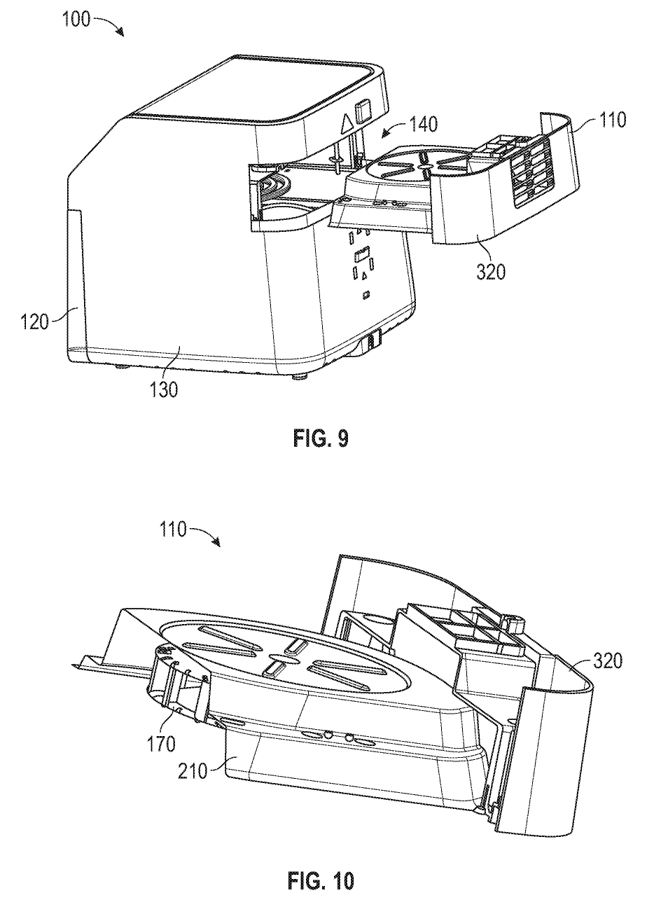

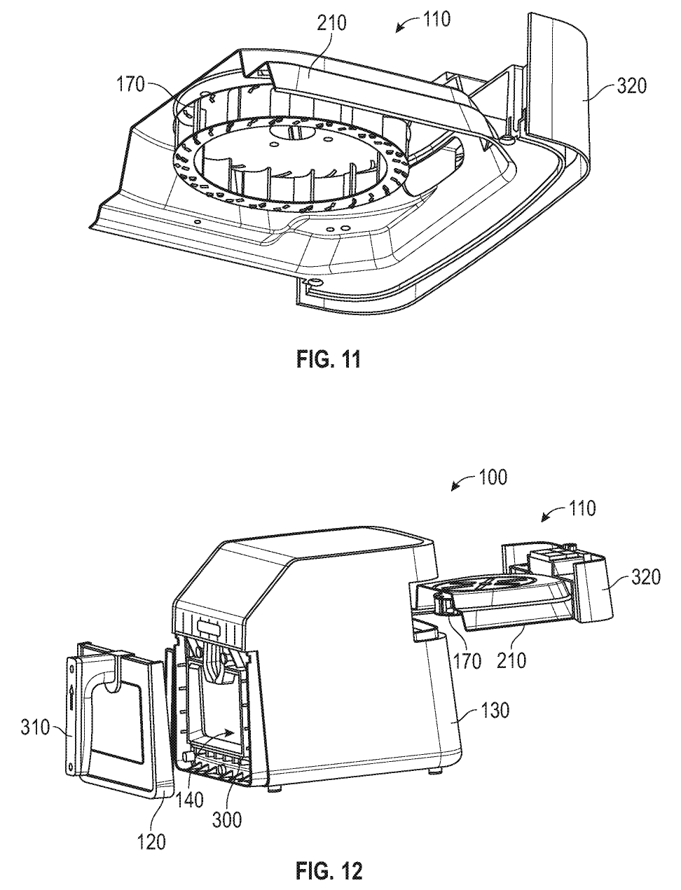

FIG. 8 is the air fryer assembly 100 of FIG. 1 with an airflow generator tray 110 removed. FIG. 9 is a rear perspective view of the air fryer assembly 100 of FIG. 1 with the airflow generator tray 110 removed. FIGS. 10 and 11 are the airflow generator tray 110 of FIG. 8. FIG. 12 is the air fryer assembly 100 of FIG. 1 with the airflow generator tray 110 and a front wall 120 of the housing 130 removed.

As shown, the air fryer assembly 100 includes a housing 130 enclosing an inner cooking chamber 140. The inner cooking chamber 140 is most clearly visible in the section views of FIGS. 5-7.

The air fryer assembly 100 further includes an airflow generator 150 for generating airflow within the inner cooking chamber 140 and a heating element 165 in a path of airflow generated by the airflow generator 150. Air circulated by the airflow generator 150 within the inner cooking chamber 140 is heated by the heating element 165.

The air fryer assembly 100 further includes a release mechanism 160 for removing the airflow generator 150 from the housing 130.

During use of the air fryer assembly 100, the housing 130 locates the airflow generator 150 and the heating element 165 relative to the inner cooking chamber 140. As such, when activated, the airflow generator 150 circulates air through the inner cooking chamber 140 such that the airflow generated passes the heating element 165 and food located within the inner cooking chamber.

When not in use, the release mechanism 160 may be activated so that the airflow generator 150, or at least a portion of the airflow generator 150, may be released and removed from the housing 130. This may allow the airflow generator 150 to be cleaned outside of the housing 130.

In order to facilitate the removal of the portion of the airflow generator 150, the air fryer assembly 100 may utilize a removable airflow module 110 or an airflow generator tray. The removable airflow module 110 may be equivalent to the airflow generator tray 110, or it may be a larger module that includes the airflow generator tray 110. In embodiments using a release mechanism 160, the removable airflow module 110 is released by way of the mechanism. A portion of the airflow generator 150 designed to be released and removable from the housing 130 is fixed within the airflow generator tray 110. The release mechanism may then allow the removal of the airflow generator tray 110 from the housing.

As shown, the airflow generator 150 may comprise multiple components, such as a fan 170 driven by a motor 180. In such embodiments, the fan 170 may be positioned within the airflow generator tray 110 and the motor 180 may be fixed within the housing 130. When removing the airflow generator tray 110 from the housing 130, the fan 170 may then be removed from the housing with the tray 110, but the motor 180 may remain fixed within the housing 130.

Accordingly, a fan shaft 190 may link the motor 180 to the driven fan 170. The release mechanism 160 may then include a fan shaft 190 release, and actuation of the release mechanism then allows for the separation of the shaft during removal of the airflow generator tray 110 from the housing 130.

As shown, the release mechanism 160 may be a button which releases the airflow generator tray 110 from the housing 130. Such a button 160 would then actuate internal mechanisms, such as a latch 200, in order to allow the removal of the airflow generator tray 110.

The airflow generator 150 may further include a shroud 210. Such a shroud may be integrated into the airflow generator tray 110, and in some cases, may be removable from the airflow generator tray 110 in order to allow for cleaning.

The airflow generator tray 110 may have multiple components or may be supplemented by a secondary airflow generator tray 220. The airflow generator tray 110 may then retain the fan 170, and the secondary airflow generator tray 220 may retain the heating element 165. In some embodiments, the airflow generator tray 110 and the secondary airflow generator tray 220 are a single unit and may be removable from the housing 130 as such. Accordingly, removal of the airflow generator tray 110 from the housing 130 removes both the airflow generator 150, or the removable portion of the airflow generator 170, as well as the heating element 165 from the housing.

Alternatively, the airflow generator tray 110 and the secondary airflow generator tray 220 may be removable either independently or in combination. Accordingly, the airflow generator tray 110 may be removed, thereby removing the airflow generator 150 but leaving the heating element 165 in place within the housing 130. When removing the airflow generator tray 110, a user may determine whether to also remove the heating element 165 and associated tray 220.

Alternatively, the secondary airflow generator tray 220 may be fixed within the housing 130, such that when the airflow generator tray 110 is removed, the heating element 165 remains in place. Where the secondary airflow generator tray 220 and the heating element 165 are fixed within the housing 130, the airflow generator tray 110 is positioned between the heating element 165 and a top 240 of the housing 130.

As shown, the heating element 165 may be a heating coil, and it may be powered by a power source associated with the housing by way of an electric contact 230 associated with the airflow generator tray 110 or the secondary airflow generator tray 220. In embodiments in which the heating element 165 is removable from the housing 130, the release mechanism may release the electric contact 230 associated with the corresponding airflow generator tray 110, 220 from the power source.

Once removed from the housing 130, the airflow generator tray 110 and/or the secondary airflow generator tray 220 may be further deconstructed, such that the airflow generator 150 and/or the heating element 165 are removable from the tray.

The air fryer assembly 100 may further include a cooking basket 300 which may be slidably received within and removable from the inner cooking chamber 140. Typically, insertion and removal of the basket 300 is by way of the front wall 120 of the housing 130. The cooking basket 300 may be integrated into the front wall 120 of the housing 130, such that the front wall of the housing and the cooking basket are removed from the inner cooking chamber 140 and from the rest of the housing 130 together.

The airflow generator tray 110 may include a portion 320 of a back surface of the housing 130. Accordingly, where the airflow generator tray 110 is removable from a back of the housing 130, it may leave an opening through which the inner cooking chamber 140 or other portions of the interior space of the housing 130 may be accessed. Where the cooking basket 300 and the front wall 120 are similarly removable from the front of the housing 130, the inner cooking chamber 140 may then be accessed for cleaning from both the front and back, as shown in FIG. 12. It is noted that in FIG. 12, the cooking basket 300 would typically be removed from the housing 130 along with the front wall 120.

Further, the front wall 120 may include an integrated or separable handle 310 in order to ease the removal of the front wall 120 and the basket 300 from the housing 130.

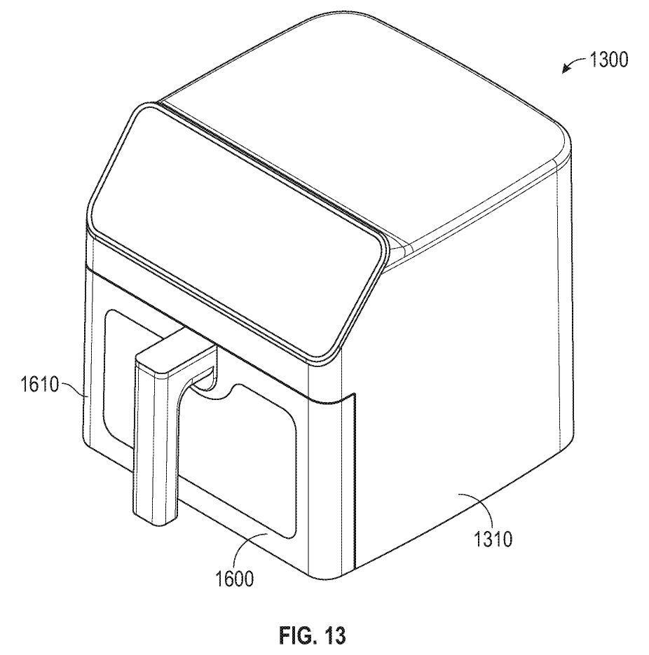

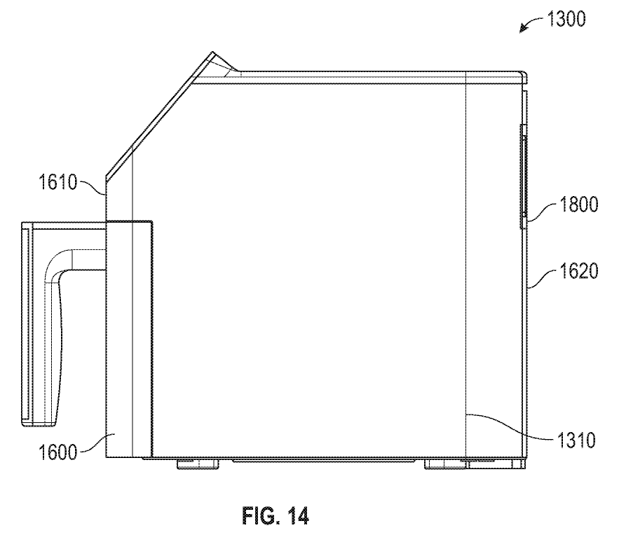

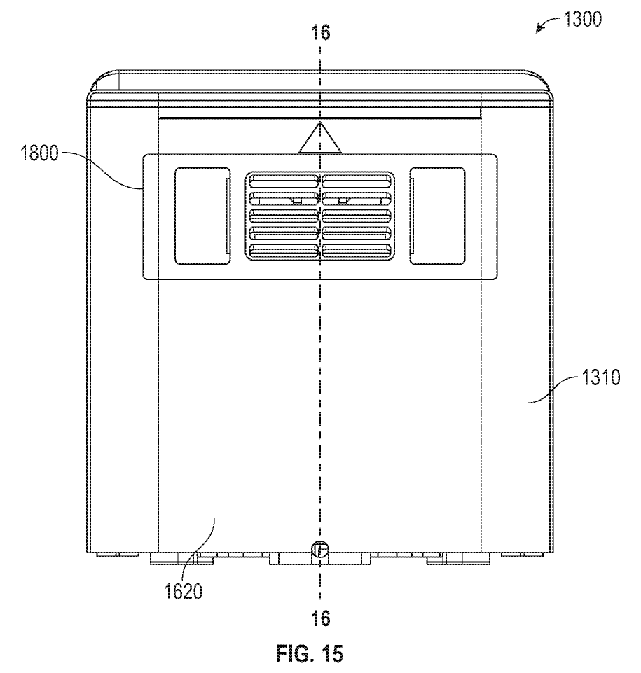

FIG. 13 is a second embodiment of an air fryer assembly 1300 in accordance with this disclosure. FIG. 14 is a side view of the air fryer assembly 1300 of FIG. 13. FIG. 15 is a rear view of the air fryer assembly 1300 of FIG. 13.

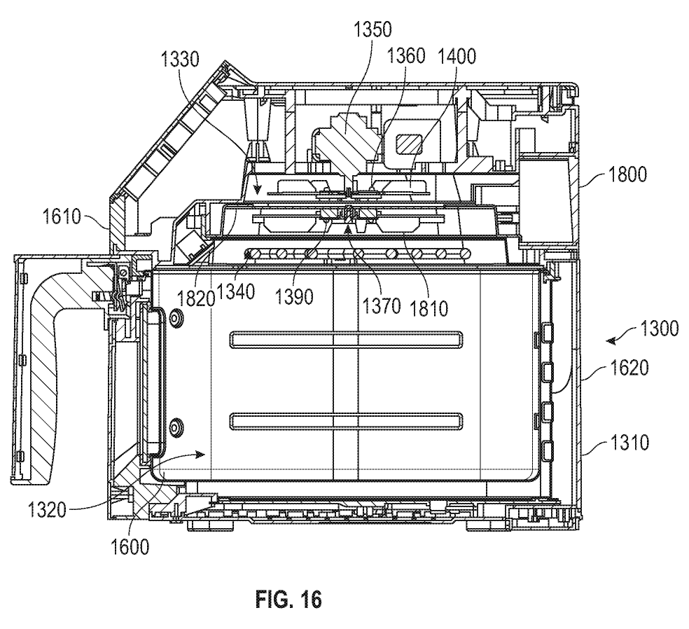

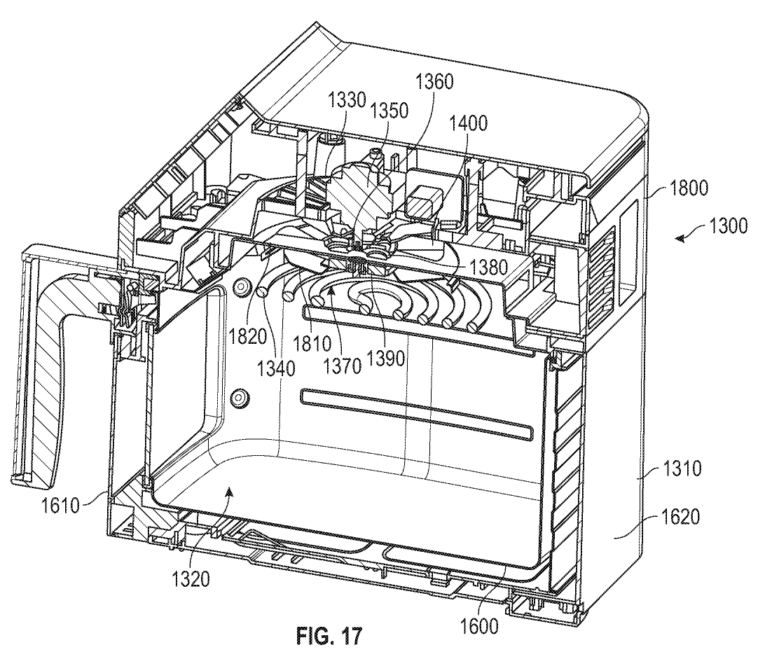

FIG. 16 is a section view of the air fryer assembly 1300 of FIG. 13 taken along line 16-16. FIG. 17 is a section perspective view of the air fryer assembly 1300 of FIG. 13 taken along line 16-16.

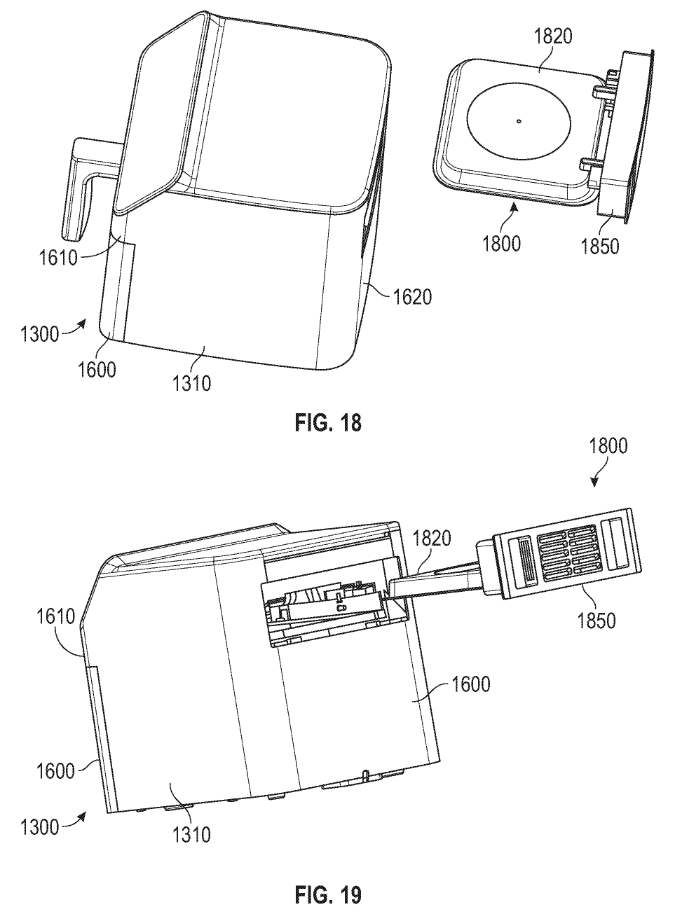

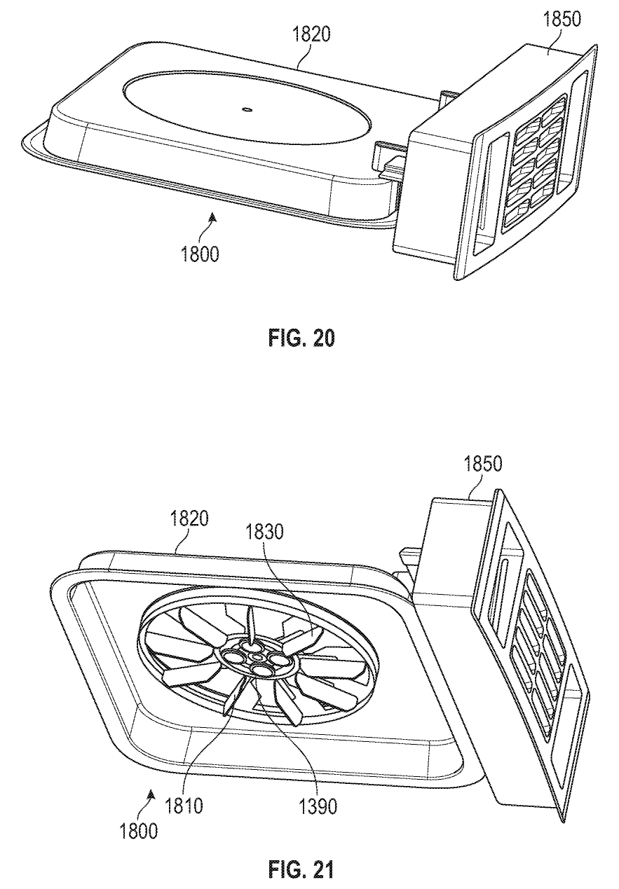

FIG. 18 is the air fryer assembly 1300 of FIG. 13 with a removable airflow module 1800 removed. FIG. 19 is a rear perspective view of the air fryer assembly 1300 of FIG. 13 with the removable airflow module 1800 removed. FIGS. 20 and 21 are the removable airflow module 1800 of FIG. 18.

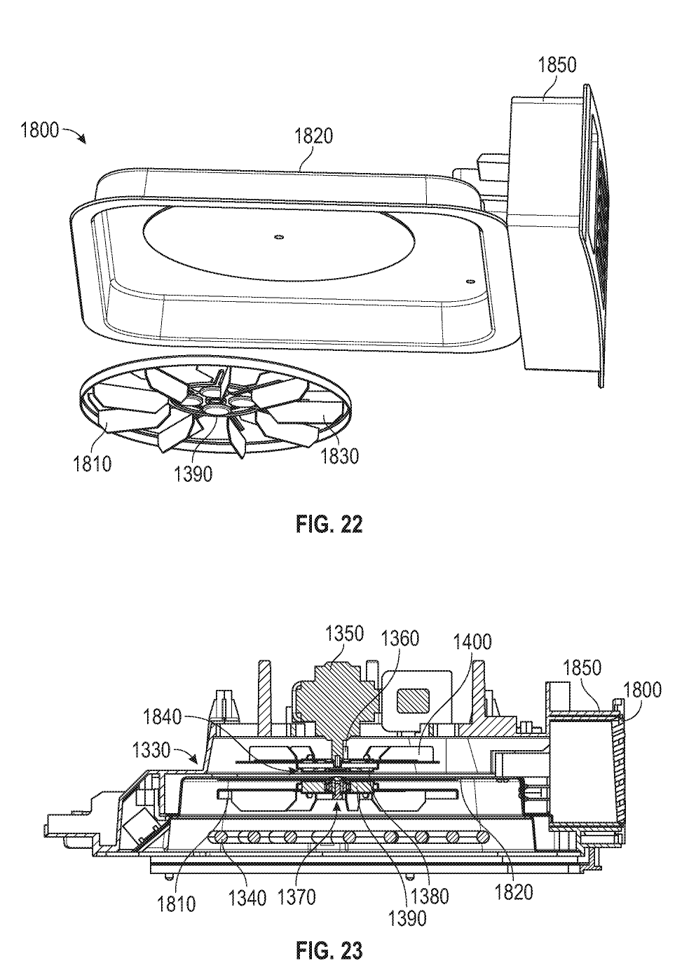

FIG. 22 is the removable airflow module 1800 of FIG. 18 with a portion of an airflow generator 1810 separated therefrom. FIG. 23 is a section view of an airflow generator 2300 for use in the air fryer assembly 1300 of FIG. 13.

In some respects, the air fryer assembly 1300 of FIG. 13 is similar to that discussed above with respect to FIG. 1. In other respects, described herein, the two embodiments differ. As shown, the air fryer assembly 1300 includes a housing 1310 enclosing an inner cooking chamber 1320. The inner cooking chamber 1320 is most clearly visible in the section views of FIGS. 16 and 17.

The air fryer assembly 1300 further includes an airflow generator 1330 for generating airflow within the inner cooking chamber 1320 and a heating element 1340 in a path of the airflow generated by the airflow generator 1330. Air circulated by the airflow generator 1330 is thereby heated by the heating element 1340.

The air fryer assembly 1300 further includes a removable airflow module 1800. The removable airflow module 1800 is removable from the housing 1310 of the air fryer assembly 1300 and contains at least a portion 1810 of the airflow generator 1330.

During use of the air fryer assembly 1300, the removable airflow module 1800 is inserted into the housing 1310 and the housing locates the airflow generator 1330 and the heating element 1340 relative to the inner cooking chamber 1320 in order to facilitate the circulation of the airflow past the heating element 1330, as discussed above.

When the air fryer assembly 1300 is not in use to heat the inner cooking chamber 1320, the removable airflow module 1800 may be removed from the housing 1310. This removal may allow the airflow generator 1330, or at least the portion 1810 of the airflow generator, such as a fan, contained in the removable airflow module 1800, to be more easily cleaned. As discussed below, in some embodiments, once removed, the removable airflow module 1800 may be further disassembled in order to facilitate further cleaning. For example, removable airflow module 1800 may include an airflow generator tray 1820 for retaining the portion 1810 of the airflow generator 1330 contained therein, and the tray 1820, the portion 1810, and other components of the removable airflow module 1800 may be separated and placed in a dishwasher or disassembled for easy handwashing.

As shown, the airflow generator 1330 may comprise multiple components, such as a fan 1810 driven by a motor 1350 and a coupling mechanism 1370. The fan may be the portion 1810 of the airflow generator 1330 contained within the removable airflow module 1800. The motor 1350 may then be fixed within the housing 1310, and the motor 1350 or a shaft 1360 of the motor may be mated with the removable airflow module 1800 by way of a coupling mechanism 1370.

Accordingly, removal of the removable airflow module 1800 from the housing 1310 decouples the coupling mechanism 1370 such that the shaft 1360 of the motor 1350 is separated from the fan 1810. Returning the removable airflow module 1800 to the housing 1310 recouples the coupling mechanism 1370 such that the fan 1810 can once again be driven by the motor 1350 by way of the shaft 1360.

As discussed above with respect to the air fryer assembly 100 of claim 1, the coupling mechanism 1370 may be a mechanical linkage which may be separable by actuating a release mechanism. In such an embodiment, the fan may be shaft driven by the motor, but the shaft may be separable by way of the release mechanism.

In the air fryer assembly 1300 of FIG. 13, the coupling mechanism 1370 is a magnetic coupling utilizing a first coupling hub 1380 fixed to, integrated into, or otherwise configured to rotate with an end of the shaft 1360 of the motor 1350 and a second coupling hub 1390 fixed to, integrated into, or otherwise configured to rotate with the fan or the portion of the fan 1810 in the removable airflow module 1800.

As shown, each of the coupling hubs 1380, 1390 may be formed from ferromagnetic material and/or a plurality of magnets configured to control orientation of the second coupling hub 1390 based on an orientation of the first coupling hub 1380.

Removal of the removable airflow module 1800 from the housing 1310 separates the first coupling hub 1380 from the second coupling hub 1390, thereby decoupling the magnetic coupling 1370. Reinsertion of the removable airflow module 1800 then recouples the magnetic coupling 1370.

When coupled, the first coupling hub 1380 is driven directly by the motor 1350 by way of the shaft 1360. The first coupling hub 1380 then applies torque across an air gap 1840 to the second coupling hub 1390 of the magnetic coupling, thereby driving the fan or portion of the fan 1810 in the removable airflow module 1800. As shown, the second coupling hub 1390 may be integrated directly into blades 1830 of the portion of the fan 1810, such that torque may be transmitted directly to the fan. While a magnetic coupling 1370 may apply torque from a first coupling hub 1380 to a second coupling hub 1390 across an air gap 1840 as shown, in some embodiments, the first and second coupling hubs 1380, 1390 may be in direct contact. Accordingly, while the magnetic attraction between the hubs allows the application of torque, there may be no gap between the two.

As shown, the airflow generator 1330 may further include a secondary fan or rotating component 1400 mated mechanically to the shaft 1360 of the motor 1350. This rotating component 1400 may incorporate the first coupling hub 1380 and, in some embodiments, may further facilitate airflow within the housing 1310.

In other respects, the air fryer assembly 1300 of FIG. 13 is similar to the air fryer assembly 100 of FIG. 1. Accordingly, in the embodiment shown, the removable airflow module 1800 does not include the heating element 1340. The heating element 1340 may be separately removable, or it may remain in place fixed within the housing 1310.

Further, once removed from the housing 1310, the removable airflow module 1800 may be further deconstructed, such that the portion of the fan 1810 may be removable from the airflow generator tray 1820, which may function as or include an integrated shroud. Similarly, in some embodiments, the airflow generator tray 1820 may be separable from a base component 1850 of the removable airflow module 1800.

The air fryer assembly 1300 may further include a cooking basket 1600 which may be slidably received within and removable from the inner cooking chamber 1320. Typically, insertion and removable of the basket 1600 is by way of a front wall 1610 of the housing 1310. The cooking basket 1600 may be integrated into the front wall 1610 of the housing 1310 such that the front wall of the housing and the cooking basket are removed from the inner cooking chamber 1320 and from the rest of the housing 1310 together.

Further, as in the air fryer assembly 100 of FIG. 1, the removable airflow module 1800 may include a base component 1850 noted above which comprises a portion of a back surface 1620 of the housing 1310. Accordingly, when the removable airflow module 1800 is removed from a back of the housing 1310, it may leave an opening through which the inner cooking chamber 1320 or other portions of the interior space of the housing 1310 may be accessed. In this way, the interior space of the housing 1310 may be accessed from the front, by removing the cooking basket 1600, or the back, by removing the removable airflow module 1800.

In the embodiment shown in FIGS. 16 and 23, the fan blades may be opposite the airflow generator tray 1820 from the first coupling hub 1380. This may result in a significant air gap 1840 along with the material of the airflow generator tray 1820 itself.

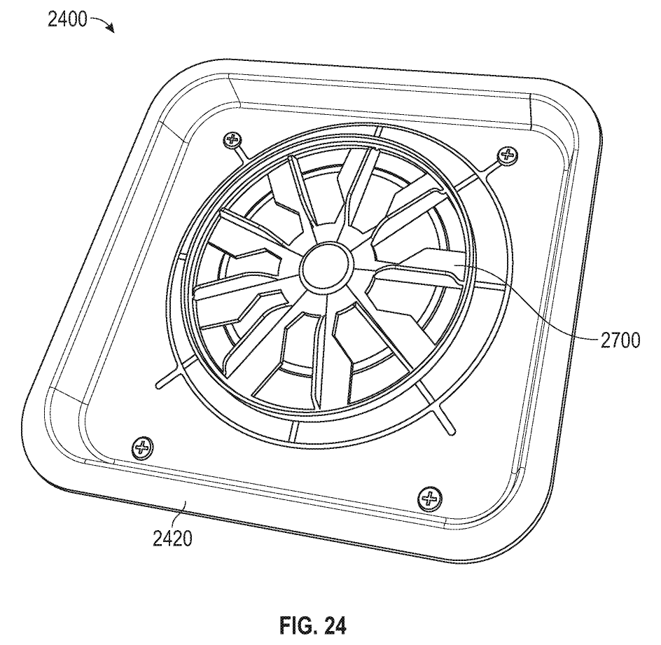

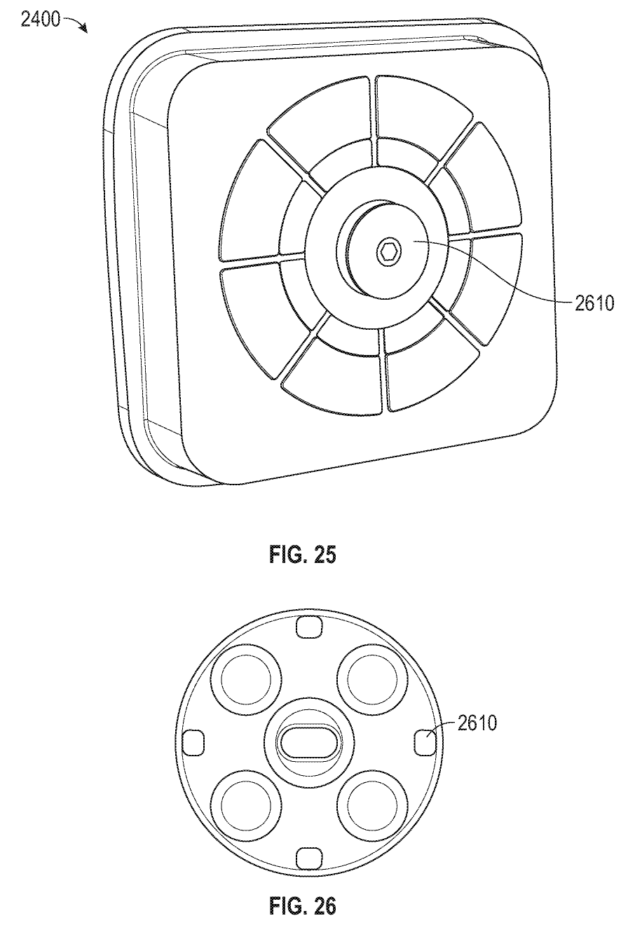

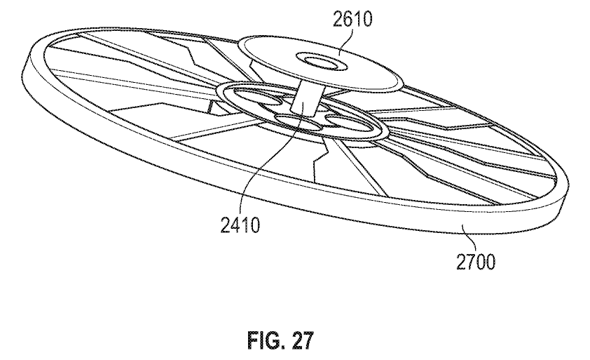

FIGS. 24 and 25 are an alternative embodiment of a removable airflow module 2400 for use in the air fryer assembly 1300 of FIG. 13. FIG. 26 is a second hub 2610 of a magnetic coupling for use in the alternative embodiment of the removable airflow module of FIG. 24. FIG. 27 shows the second hub 2610 of the magnetic coupling of FIG. 26 mated with a portion 2700 of an airflow generator removed from the removable airflow module 2400 of FIG. 24.

As shown, the second hub 2610 of the magnetic coupling of the removable airflow module 2400 of FIG. 24 is mated to the corresponding portion 2700 of the airflow generator, in this case the fan, by way of a fan shaft 2410. The fan shaft 2410 then passes through an airflow generator tray 2420 of the removable airflow module 2400 such that the fan 2700 and the second hub 2610 of the magnetic coupling are on opposite sides of the airflow generator tray 2420.

When the removable airflow module 2400 of FIG. 24 is integrated into the air fryer assembly 1300 of FIG. 13, it thereby shrinks or eliminates the air gap 1840 visible in FIGS. 16 and 23. Accordingly, by placing the second hub 2610 of the magnetic coupling opposite the tray 2420 from the fan 2700, the first and second hub of the magnetic coupling may be in direct contact with each other when fully inserted into the housing. Further, as noted above, when the removable airflow module 2400 is removed, it may be further disassembled such that each of the fan 2700, the airflow generator tray 2420, and the second hub 2610 of the magnetic coupling may be more easily cleaned.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An air fryer assembly comprising:
a housing enclosing an inner cooking chamber;
an airflow generator for generating airflow within the inner cooking chamber;
a heating element in a path of airflow generated by the airflow generator, such that air circulated by the airflow generator within the inner cooking chamber is heated by the heating element; and
a removable airflow module, the removable airflow module containing at least a portion of the airflow generator, and wherein the removable airflow module is removable from the housing;
wherein during use of the air fryer assembly, the removable airflow module is inserted into the housing and the housing locates the airflow generator and the heating element relative to the inner cooking chamber.

2. The air fryer assembly of claim 1 wherein the removable airflow module comprises an airflow generator tray, wherein the portion of the airflow generator is fixed within the airflow generator tray, and removal of the removable airflow module includes removal of the airflow generator tray from the housing.

3. The air fryer assembly of claim 2 wherein the airflow generator is a motorized fan comprising a fan driven by a motor, and wherein the fan or a portion of the fan is positioned within the airflow generator tray and the motor is fixed within the housing, and wherein upon the removal of the airflow generator tray from the housing, the motor remains fixed within the housing.

4. The air fryer assembly of claim 3 further comprising a release mechanism for enabling or actuating the removal of the removable airflow module from the housing.

5. The air fryer assembly of claim 4, wherein the release mechanism includes a fan shaft release, and wherein actuation of the release mechanism allows for the separation of a shaft driven by the motor from the airflow generator.

6. The air fryer assembly of claim 4 wherein the release mechanism is a button which releases the removable airflow module from the housing.

7. The air fryer assembly of claim 3 further comprising a magnetic coupling for mating the motor with the fan or portion of the fan, such that removal of removable airflow module from the housing decouples the magnetic coupling and reinsertion of the removable airflow module recouples the magnetic coupling.

8. The air fryer assembly of claim 7 wherein a first hub of the magnetic coupling is fixed to an end of a shaft of the motor and applies torque to a second hub of the magnetic coupling fixed to the fan or portion of the fan.

9. The air fryer assembly of claim 8 wherein the second hub is integrated into the fan or the portion of the fan.

10. The air fryer assembly of claim 8 wherein the second hub is mated to the fan or the portion of the fan by way of a fan shaft, and wherein the fan shaft passes through the airflow generator tray such that the fan or portion of the fan and the second hub are on opposite sides of the airflow generator tray.

11. The air fryer assembly of claim 2 wherein the airflow generator further comprises a shroud, and wherein upon removal from the housing, the portion of the airflow generator and the shroud are removable from the airflow generator tray.

12. The air fryer assembly of claim 2 wherein the heating element is fixed within the airflow generator tray and located relative to the airflow generator by the airflow generator tray, and wherein removal of the removable airflow module from the housing removes both the airflow generator and the heating element from the housing.

13. The air fryer assembly of claim 12 wherein the heating element is a heating coil powered by a power source associated with the housing by way of an electric contact associated with the removable airflow module, and wherein removal of the removable airflow module disconnects the electric contact associated with the removable airflow module from the power source.

14. The air fryer assembly of claim 12 wherein the removable airflow module is provided in two parts, such that a portion of the removable airflow module associated with the airflow generator may be removed from the housing in combination with or independently of a portion of the removable airflow module associated with the heating element.

15. The air fryer assembly of claim 12 wherein upon removal from the housing, the airflow generator and the heating element are removable from the removable airflow module.

16. The air fryer assembly of claim 2, wherein the heating element is fixed within the housing, and wherein during use, the airflow generator tray is positioned between the heating element and a top of the housing.

17. The air fryer assembly of claim 1 further comprising a cooking basket slidably removable from the inner cooking chamber, wherein the cooking basket slides out of the inner cooking chamber by way of a front wall of the housing.

18. The air fryer assembly of claim 17 wherein the cooking basket is integrated into the front wall of the housing, such that the front wall of the housing and the cooking basket are removed from the inner cooking chamber together.

19. The air fryer assembly of claim 17 wherein the removable airflow module is removable from a back wall of the housing, and wherein upon removal of the cooking basket and the removable airflow module from the housing, the inner cooking chamber is accessible for cleaning through both the front wall and the back wall.
